(19) United States
(12) Patent Application Publication
(10) Pub. No.: US 2005/0039358 A1
(43) Pub. Date: Feb. 24, 2005

(54) Extended snowfall snow globe

(76) Inventor: Willis Elmer Rust, Golden Valley, AZ (US)

Correspondence Address: WILLIS E. RUST, 3420 W. CHEA DR., GOLDEN VALLEY, AZ, 86413, US

(21) Appl. No.: 10/917,017

(22) Filed: Aug. 12, 2004

Related U.S. Application Data
(60) Provisional application No. 60/496,280, filed on Aug. 18, 2003.

(51) Int. Cl. G09F 19/00

(52) U.S. Cl. 40/410

(57) ABSTRACT

This invention is a snow globe with enhanced viewing pleasure due to a significantly extended snowfall effect. The extended snowfall is achieved with the use of “snow reservoirs” at both the top and bottom of the snow globe. The simulated snow floats down out of the top reservoir at a restricted rate through holes into the viewed area of the snow globe and then into the snow reservoir at the bottom. After all the snow has settled into the bottom snow reservoir the snow globe can be turned horizontally 180 degrees to instantly begin the simulated snowfall again. The figure or scene in the viewed area is designed to always rotate into the upright position within the viewed area no matter what angle or position the snow globe is in.

### CROSS-REFERENCE TO RELATED APPLICATIONS

Provisional Application for Patent. USPTO Provisional Ser. No. 60496280 filed Aug. 18, 2003.

### STATEMENT REGARDING FEDERALLY SPONSORED RESEARCH OR DEVELOPMENT “NOT APPLICABLE”

### REFERENCE TO SEQUENCE LISTING, A TABLE OR A COMPUTER PROGRAM LISTING COMPACT DISC APPENDIX “NOT APPLICABLE”

### BACKGROUND OF THE INVENTION

1. Field of Invention

The present invention relates to snow globes or such items designed to simulate snowfall within a fluid filled transparent container. More specifically the present invention relates to snow globes and similar devices designed to create a snowfall effect for longer lasting or extended periods of time.

2. Description of the Prior Art

Snow globes or such items which are designed in such a way as to prolong the period of time in which the snowfall effect last, have in prior art required the use of mechanical moving parts and some kind of power to move the mechanical parts. The present invention uses no mechanical moving parts and requires no power source to create an extended snowfall effect. With no mechanical moving parts there are virtually no parts to wear-out, and production costs are less.

U.S. Pat. No. 5,442,869 McDarren et al. uses a pump assembly to circulate a fluid and particles in an outer globe surrounding an inner globe.

U.S. Pat. No. 5,666,750 Segan et al. uses a rotating compartment, rotated by a mechanical means, such as a motor to continually circulate flake like particles.

U.S. Pat. No. 6,205,689 B1 TenBrink uses a pump to create water currents around the perimeter of a display tank. Water is propelled out of a pump into an outflow tube extending down a first side of the display tank into a receiving trough on the bottom of the tank where the current picks up pellets in the trough and carries them to a deflector plate on the other side of the tank which diverts the pellet to the upper side of the tank where they spread out and descend to the bottom creating a simulated snowfall.

U.S. Pat. No. 6,263,600 B1 Brink uses a drive unit of some sort to rotate a container filled with fluid and elements such as small pellets which are caught or trapped by vanes attached to the inner surface of the container and moved to the top of the container creating a simulated snowfall.

U.S. Pat. No. 6,357,151 B1 Yuen uses a power driven agitator to agitate fluid and a particulate such as artificial snow or leaves inside of a transparent envelope creating the effect of falling snow, leaves, or the like.

U.S. Pat. No. 6,415,535 B1 White et al. uses a magnetic propeller driven by an electric motor through a magnetic couple created between a magnetic rotor and the magnetic impeller forcing circulation of fluid that entrains and disperses ornamental particles inside of a transparent enclosure.

### SUMMARY OF THE INVENTION

The present invention is a snow globe, which has an extended snow fall effect as compared to most typical snow globes on the market today. The present invention is not shaken as most typical snow globes are, but is rather turned horizontally 180 degrees to allow the artificial snow to flow out of a top reservoir through a divider with numerous holes through it, through the viewed area of the snow globe and then settle into a second reservoir at the bottom of the snow globe. When the snow globe is turned horizontally 180 degrees again, the bottom reservoir (full of the artificial snow) becomes the top reservoir and the top reservoir (empty of artificial snow) becomes the bottom reservoir, and the process of snow flowing from top to bottom begins again.

In the viewed area of the snow globe is a miniature figure of a person, animal, object, building scene or such. The object used in the viewed area, whether it be a miniature figure, building, scene, etc., is significantly lighter than water at what is the top end and heavier than water at the bottom end, and the entire object as a whole unit is just slightly heavier than water. Depending on how the snow globe is positioned at a given time the miniature will always settle to the bottom end of the viewed area in an upright position, due to the top end being lighter than water and the bottom end being lighter than water and the whole unit being slightly heavier than water. The miniature responds in the same way as a hammer does in a bucket of water, with the wooden handle pointing upwards towards the surface and the head of the hammer resting on the bottom of the bucket.

Most typical snow globes after having been shaken and then put at rest have a snowfall effect of usually no more than 5 to 10 seconds. The present invention after having been turned horizontally 180 degrees to create the snowfall effect, has a snowfall effect lasting significantly longer than typical snow globes. A current prototype has the snowfall effect lasting around 80 seconds with a reservoir containing ¾ inches of artificial snow after all the snow has settled into the bottom reservoir. The longer lasting snowfall effect creates a more pleasurable viewing experience.

### BRIEF DESCRIPTION OF THE DRAWINGS

FIG. 1 is a perspective view of the present invention showing it as it would be viewed by a viewer after the unit has been turned 180 degrees, the miniature having rotated within the globe and having settled in an upright position on the bottom side of the viewing area, and artificial snow flowing out of the currently top reservoir, down through the viewed area, and settling into the currently bottom reservoir.

FIG. 2 is a plan view showing the various parts of the present invention.

FIG. 3 is a perspective view in motion showing the present invention in a vertical position, half-way through a 180 degree turn, as shown by direction of arrows 15-15. When the 180 degree is completed, end A 11, which was the bottom end before the turn, will become the top end, and end B 12, which was the top end will become the bottom end. The snowman miniature inside the viewed area is shown to be rotating within the viewed area, as shown by arrows 16-16. The snowman miniature rotates at the same time as the snow globe is being rotated since the miniature continues to remain in an upright position due to the bottom of the miniature being heavier than water and the top of the miniature being lighter than water.

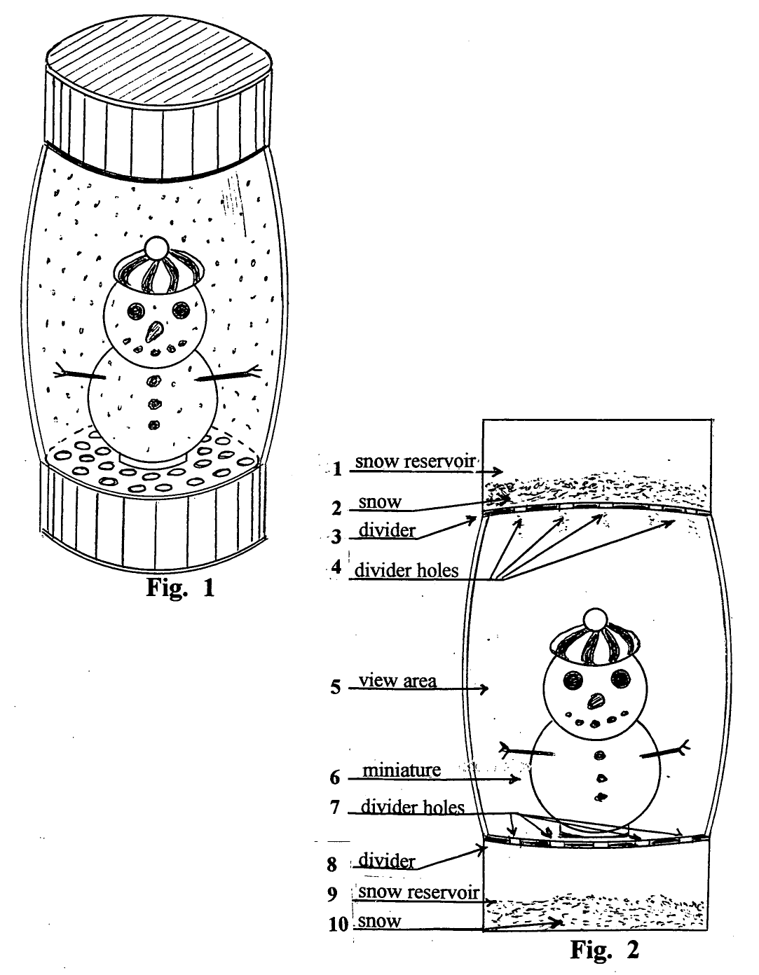

### DETAILED DESCRIPTION OF THE INVENTION

The present invention is a snow globe with a snowfall effect which is significantly longer in duration than the snowfall effect of most typical snow globes on the market today.

Referring to FIG. 2, the plan view of the present invention illustrates the various parts which make the snowfall effect last longer than the snowfall effect in typical snow globes. At the top end of the snow globe is a snow reservoir 1 and also a snow reservoir at the bottom end 9. Between the view area 5 of the snow globe and the top snow reservoir 1 is a divider 3. Also between the bottom snow reservoir 9 and the view area 5 is another divider 8. The artificial snow 2 in the top reservoir 1 flows out and into the view area 5 through holes in the top divider 4. The holes in the top divider 4 restrict the flow of snow 2 out of the top snow reservoir 1 into the view area 5 which creates the longer lasting snowfall effect in comparison to typical snow globes.

After snow from the top reservoir 1 has fallen down through the view area it continues on down into the bottom reservoir 9 through the holes 7 in the bottom divider 8. After the snowfall effect has completed and all of the snow has fallen from the top reservoir 1 and settled into the bottom reservoir 9, the snowfall effect can be started over by turning the snow globe horizontally 180 degrees, thereby making what was the bottom reservoir 9 the top reservoir 1, and making what was the top reservoir 1 the bottom reservoir 9. After turning the snow globe horizontally 180 degrees the snow, which had all settled into the bottom reservoir 9 is now in the top reservoir 1, since what used to be the bottom reservoir 9 is now the top reservoir 1. With all of the snow now in the top reservoir 1 the snowfall effect will begin again in the same way as described earlier.

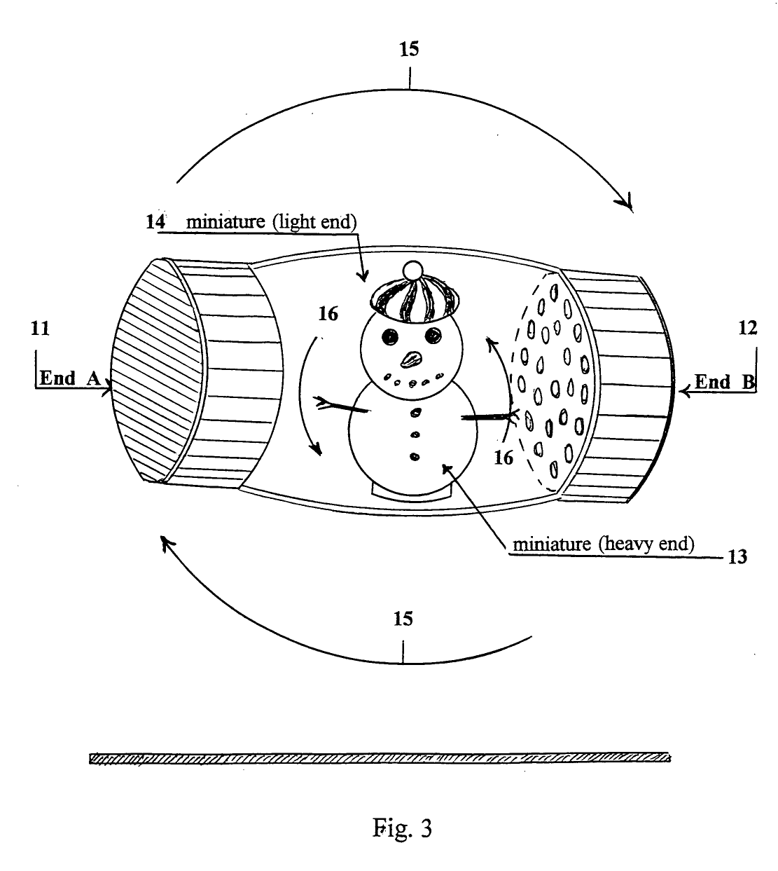

Inside the view area of the snow globe is a miniature figure of a person, animal, object, building, scene, or such 6. In the drawings I depict a miniature snowman 6. When the snow globe is turned 180 degrees the miniature 6 remains in an upright position and comes back to rest on the bottom side of the view area 5. Whatever is used as the miniature 6 in the view area (whether it is a figure of a person, animal, object, building, scene or such), it is much lighter than water at the top end 14 and heavier than water at the bottom end 13 and the unit as a whole 6 being slightly heavier than water as illustrated in FIG. 3. In FIG. 3 I illustrate how when the snow globe is rotated the miniature inside the view area rotates within the view area and remains in an upright position. When the snow globe is in vertical position the miniature 6 comes to rest in an upright position at the bottom of the view area.

1. A simulating snow scene device comprising:
a) a housing with a transparent central area;
b) areas at the two ends of said central area separated by dividers from the said central area;
c) holes in said dividers to allow restricted passage of artificial snow both into and out of said end areas as well as into and out of said central area.

2. A miniature figure of a person, animal, object, building or scene made for use in claim 1 and comprising:
a) a hollow air filled area in the upper portion of said miniature or the use of very light materials in the manufacture of upper portion of said miniature;
b) a bottom portion of said miniature made of materials heavier than water;
c) the said upper and said bottom portions combined to make a complete unit which will always remain in an upright position and always settle to the lowest area in said central area of claim 1 regardless of what angle or position claim 1 is in.
